(19) United States
(12) Patent Application Publication
(10) Pub. No.: US 2012/0310752 A1
(43) Pub. Date: Dec. 6, 2012

(54) System, method, and computer program product for Data Entry Free electronic purchasing

(75) Inventor: SEAN GADDIS, LAS VEGAS, NV (US)

(73) Assignee: KAWS, INC., LAS VEGAS, NV (US)

(21) Appl. No.: 13/153,816

(22) Filed: Jun. 6, 2011

(51) Int. Cl. G06Q 30/00

(52) U.S. Cl. 705/14.73

(57) ABSTRACT

Systems, methods and computer program products for the secure, efficient, and accurate purchasing of products and services electronically without the User entering any alpha numeric data (e.g., login, password, shipping address, credit card and bank account information). In response to an advertisement sent to a User's electronic communications account (e.g. email account), a purchase is made by clicking on a hyperlink within the electronic message, wherein they are redirected to a webpage confirming the purchase. Within the webpage, non-verified Users must subsequently select the form of electronic communications to receive from the Offer Provider in order to confirm the purchase again or to cancel the order. Forms of electronic communications comprise email, SMS/text, or phone call with their verbal response. In all scenarios, the User must have previously provided the merchant, or Offer Provider, with their electronic communications address, billing information, and possibly shipping information, such as through a previous purchase.

### PRIORITY CLAIM

The present application is a continuation-in-part of and claims priority to U.S. Utility patent application Ser. No. 13/153,816 filed Jun. 6, 2011 by Sean Gaddis, entitled “System, method, and computer program product for electronic purchasing without alpha numeric data entry”, the teachings of which are incorporated herein by reference in their entirety.

### FIELD OF THE INVENTION

The present invention relates to computer implemented methods and systems for the purchasing of products and services via electronic communications devices without alpha numeric data input.

### BACKGROUND OF THE INVENTION

The online direct advertising and discount industry has exploded over the past few years becoming a multi-billion dollar industry, and one of the hottest and fastest-growing business sectors in the world. Advertisements can be sent directly to potential buyers (i.e. Users) via email, SMS-text, Instant Messaging, Tweets, Facebook posts, and other emerging formats. The advertisements originate from Offer Providers (OP), who are either merchants or third party service providers representing merchants. Advertisements from Offer Providers require the buyer to input (or login to confirm) their personal and billing information with each website visit wherein a purchase is made. For example, FIGS. 1A-B display a typical prior art software application or service of a User receiving an email message on their mobile device, then having to log into their account and initiate payment with their credit card on file or by entering non-stored billing information, or by logging into their PayPal account. These methods are not only laborious for Users, but lead to lower sales for Offer Providers due to Users having to input payment information and/or login credentials.

Additionally, there has recently been an explosion of electronic advertising and promotion due in part to the increase in electronic promotional delivery vehicles including online banners, text ads, emails, SMS, IMs and social media. There has also been a significant increase in the quantity and types of electronic communication devices which can receive electronic promotions including desktop and laptop computers, smartphones and mobile computing devices such as tablets. If the above trends are laid out in order, the conclusion drawn is that increasingly promotional messages are delivered to devices, such as smartphones, where the reading and responding to these promotional messages by the User is very difficult, particularly when alpha numeric data input from a mobile keyboard is required. This translates into a suboptimal experience on the User side and suboptimal economics on the Offer Provider side (increased costs, decreased purchases).

The prior art requires that the User at some point be authenticated, either by the merchant and/or by the payment service after the User clicks on an advertisement. For example, Amazon.com utilizes a “Shopping cart” method and a “1-Click®” method for a User purchasing a product or service over the Internet (e.g., See U.S. Pat. No. 5,960,411 entitled “Method and System for Placing a Purchase Order via a Communications Network”). The method requires that the User must login (provide username and password) to their account with the Offer Provider (either the merchant or their service provider). There is also a 1-click method that allows the merchant to not have the User login to Amazon; but, the merchant must still verify the User is who they say they are, which is typically done through a login to the merchant. The prior art thus requires the User at some point to be authenticated, either by the merchant and/or by the payment service after the User clicks on an advertisement. There is a need within the art for a method to authenticate the User prior to sending the advertisement, and then re-verify the authenticity of the User after they have placed a purchase.

Therefore there is a need within the industry for a secure, more efficient, and accurate method of purchasing products and services while not requiring alpha numeric data input (e.g., login, password, shipping address, credit card and bank account information) on a User's electronic communications device keypad. In particular, there is a need for enhanced Internet purchasing methods for User's with electronic account addresses, shipping and billing information previously accessible to an Offer Provider, wherein: 1) no financial or personally identifiable data is required to complete the transaction because the identity of the User has already been authenticated, and 2) no alpha numeric data entry from a keypad is required (e.g., no username, password or credit card information passes over the Internet).

### SUMMARY OF THE INVENTION

The present invention is to systems, methods, and computer program products for an Offer Provider to transmit an advertisement for products or services to a User's electronic communications account (versus within merchant managed websites or applications), and for the User to place the purchase from the account, then be redirected to a webpage confirming the purchase. The Offer Provider may also select from various methods permitting a non-verified User the ability to confirm again or cancel the purchase, wherein the User is never required to enter any personal or financial account information, and whereby the User is never required to enter any alpha numeric information into a keypad or keyboard of their computing device.

The Offer Provider is required to have the User's following information on file prior to sending the advertisement: contact information (e.g. email addresses), shipping information if required, and billing information sufficient to complete a financial transaction. Embedded within the communication is a Promotionally Enabled Link or PEL (e.g., email link, SMS link, or link posted on a User's social media site such as Facebook® or Twitter®) permitting the User to purchase the services and/or product without entering any alpha numeric data, such as account login and password, personal contact or financial account information. In a preferred embodiment, the Offer Provider (OP) sends a Promotional Message (PM) to a User's personal computing or mobile communications device with World Wide Web browsing or cellular network transmission capabilities. The system and method of the present invention may be implemented by an Offer Provider who is either a merchant or a third party service provider representing multiple merchants.

Another feature of the present invention comprises a computer program product, a system and a method for a User to instantly verify or confirm that they have placed an order with an Offer Provider and that the order is accurate (e.g. correct product, quantity, color, price, shipping address, etc. . . . ) without having to log into the Offer Provider's webpage, and without having to enter any alpha numeric data.

Another feature of the present invention is secure and improved purchase order accuracy by preventing a person, who is not the original User that received the Offer Provider's electronic advertisement, from charging the User's financial accounts. In situations where the original User voluntarily shares the advertisement with a Non-User entity, for example by forwarding an email to a friend, when the friend attempts to place an order, they will be directed to the Offer Provider's other venues for electronic purchasing. And for situations where a Non-User entity accidently or fraudulently attempts to bill the original User, an electronic communication is sent to the original User account confirming the purchase, wherein the User would decline the purchase by not clicking on the embedded link.

Another feature of the present invention comprises a single click purchase process from a User's ECA (Electronic Communications Account), herein known as the “ECA Single Click Method”. With one click from a promotional message sent to a User's ECA, the User can place a purchase and receive a confirmation of it in the form of an Offer Provider message at a website. It is applicable for a User whose identity has been previously verified by the Offer Provider. Prior verification occurs in situations wherein the User has already logged into the merchant's website, has saved their username and password on their electronic communications device, and/or is verified by the merchant via web browsers having saved their credentials.

And a further feature of the present invention comprises a method herein known as the “User Controlled Confirmation Method”. It provides the User the option of selecting the method by which they wish to confirm their purchase (e.g. email, SMS/text, or phone call from the Offer Provider or Service Provider). This is a “double opt-in confirmation” method wherein the first confirmation comprises redirection to an Offer Provider webpage after the User places the purchase, such as by clicking on the “Buy” tab within an email, which is followed by a second confirmation in the form of communication that the User has designated (e.g. email, SMS, or phone call). This second confirmation message also provides the User the ability to cancel the purchase in lieu of confirming it.

### BRIEF DESCRIPTION OF THE DRAWINGS

A computer-implemented product and service purchasing process that embodies the above and other inventive features will now be described with reference to the following drawings:

FIGS. 1A and 1B illustrate a prior art example of purchasing a product from a promotional message sent to a User's electronic communications account (ECA) for example, an email account, as viewed on an Electronic Communications Device, which requires the User to enter alpha numeric data (e.g. login, password, and financial account information) via a process that requires multiple input steps.

FIGS. 2A and 2B illustrate an exemplification of the present invention of a promotional message sent by an Offer Provider to a User's electronic communications account (ECA) for example, an email account, as viewed on their Electronic Communications Device, and requiring the User to click only 3 links to purchase the item without entering alpha numeric data.

FIGS. 3A and 3B illustrate an exemplification of the present invention using a promotional message sent by an Offer Provider to a User's social media or networking site as viewed on their Electronic Communications Device, and requiring the User to click only 3 links to purchase the item without entering alpha numeric data.

FIG. 4A is a block diagram of a system architecture of the present invention comprising a service provider transmitting ECA' s and forwarding confirmed purchase orders to merchants for billing and shipping. FIG. 4B illustrates a flowchart of events for an Offer Provider to send an advertisement and process a User purchase without transmitting the User's personal or financial information over the Internet.

FIG. 5 illustrates an exemplification of the “ECA Single Click Method” for a User to make a purchase and confirm a purchase in a single click from a promotional message in a User's electronic communications account (ECA).

FIGS. 6A and 6B illustrate an exemplification of the “User Controlled Confirmation Method”. FIG. 6A demonstrates a User having to select how they would like to confirm a purchase (email, SMS, or phone call). FIG. 6B demonstrates that the User has chosen to confirm via email.

FIG. 7 illustrates an exemplification of the “User Controlled Confirmation Method”, wherein the User selected confirmation via SMS/text following the steps in FIG. 6A.

FIG. 8 illustrates an exemplification of the “User Controlled Confirmation Method”, wherein the User selected confirmation via a verbal response to a telephone call following the steps in FIG. 6A.

FIG. 9 illustrates a flowchart of events for an Offer Provider to send a promotional message and process a User purchase without transmitting the User's personal or financial information over the Internet for the “User Controlled Confirmation Method”.

FIG. 10 illustrates a flowchart of events for an Offer Provider to send a promotional message and process a User purchase without transmitting the User's personal or financial information over the Internet for the “ECA Single Click Method”.

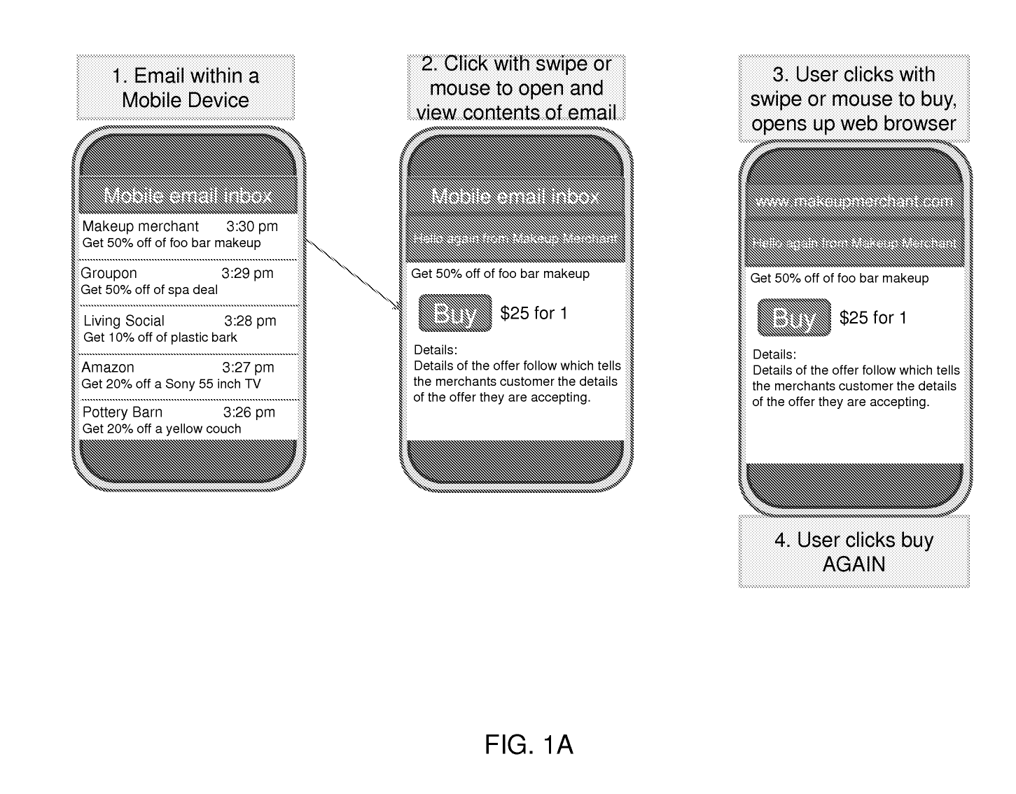

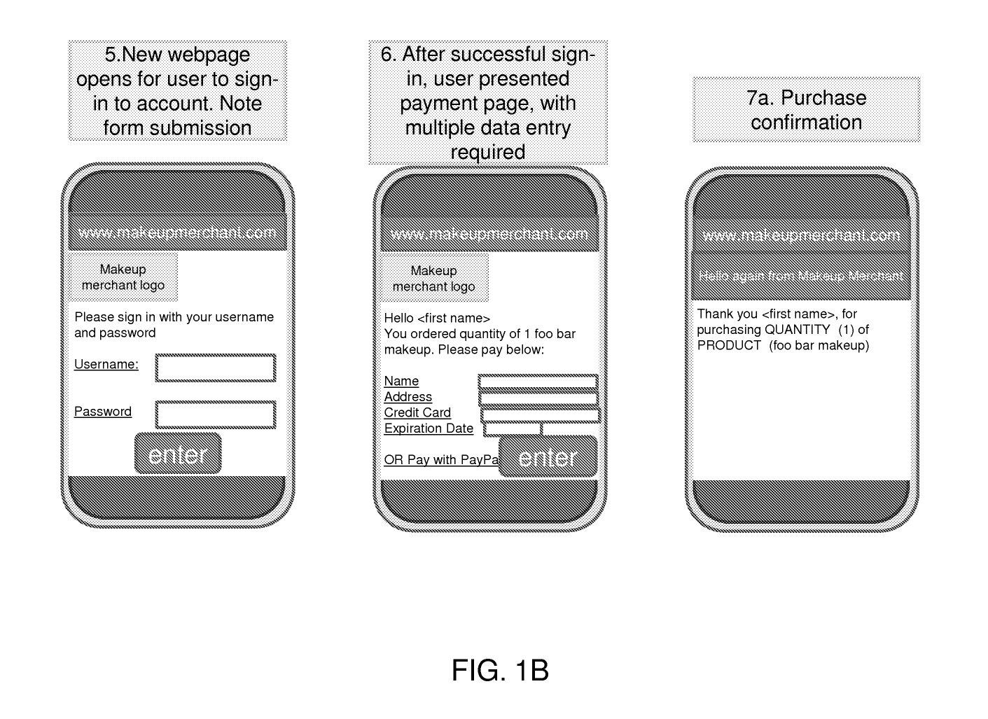

### DETAILED DESCRIPTION

The following definitions and methods are provided to better define the present invention and to guide those of ordinary skill in the art in the practice of the present invention. Unless otherwise noted, terms are to be understood according to conventional usage by those of ordinary skill in the relevant art.

As used herein, the term “application programming interface (API)” refers to a particular set of rules and specifications that software programs can follow to communicate with each other.

As used herein, the term “Click” refers to any individual step taken by User that does not involve alpha numeric input from an electronic device, such as a computer or mobile keyboard. Clicks include any non-key stroke computer input comprising, for example, swipes, screen taps, computer mouse clicks, etc. . . .

As used herein, the term “Electronic Communications Account (ECA)” refers to any User owned account including landline telephone, mobile phone, email, SMS, IM Instant Messages and posts, including social network accounts, etc. . . . by which User receives electronic alpha numeric Promotional Messages.

As used herein, the term “link” is used to refer to any item on a webpage or an electronic communication (e.g. email link, SMS link, or link posted on a User's social media site such as Facebook® or Twitter®) that when clicked (i.e., activated), opens a connection (i.e., “jumps” or redirects) to another website, webpage, or delivers more information on the existing webpage.

As used herein, the terms “module or system” represent hardware, software, firmware or a combination of these elements, or yet some other kind of implementation. For instance, in the case of a software implementation, the terms module or system represent computer program code that performs specified tasks when executed on a processing device or devices (e.g., CPU or CPUs). The program code can be stored in one or more machine-readable media.

As used herein, the term “machine-readable medium” or the like refers to any kind of medium or media for retaining and storing information in a machine readable form, including the use of various kinds of storage devices (magnetic, optical, static, etc.). The term also encompasses transitory forms of representing information, including various hardwired and/or wireless links for transmitting the information from one point to another.

As used herein, the term “Non-User entity” refers to any individual or organization of individuals engaging in unauthorized billing of a User's financial accounts, such as those involved in identity theft or friends of a User to whom the User has forwarded a promotional message.

As used herein, the term “Offer Provider (OP)” refers to any merchant who promotes directly to User or aggregator such as Groupon® who promotes to User on behalf of merchants. The later may also be known as a “Service Provider” (SP), who is an OP who has been contracted by the merchant to transmit advertisements to Users (in lieu of the merchant), receive User's electronic purchase orders, confirm User's orders, and notify merchants to process orders and ship items. Billing of Users' financial accounts may be conducted by the merchant or by the SP. In a preferred embodiment of the present invention, only the merchant has access to Users' financial accounts, and billing is conducted by the merchant.

As used herein, the term “Offer Provider Payment Gateway” refers to an e-commerce service that authorizes payments for the merchant.

As used herein, the term “Promotionally Enabled Link (PEL)” refers to a computer programming link generated as part of invention that contains Promotional Information, is encrypted before sending to User and decrypted by OP to facilitate purchase or acceptance of offer when clicked on by User, and has special capabilities to both properly direct User to offer as well as track and report on User actions.

As used herein, the term “Promotional Information (PI)” refers to data fields from an OP that may include, but are not limited to: unique User ID #, promotional offer, target URL etc. . . .

As used herein, the term “Promotional Message (PM)” refers to any electronic alpha numeric message generated by an OP and sent to an ECA for purposes of promoting a product or service offering.

As used herein, the term “User” refers to any person who receives promotional offers due to authentication through previous registration, account creation and opt in for promotions from Offer Provider. For the present invention, the User is a pre-existing customer of Offer Provider or merchant represented by Offer Provider for whom the Offer Provider or merchant has billing information available that is sufficient to process a purchase order.

As used herein, the term “Universal Resource Locator (URL)” is used to refer to an Internet address for a Web page or Web site. A link to a Web site usually contains a URL. The terms “URL” and “link” are used interchangeably. In the present invention, activation of the URL comprises a User clicking of a link to the URL on a web page, a User clicking of a link to the URL in an electronic communication (e.g. e-mail), or an executing of a computer program that activates a link to the URL.

The present invention is to a computer implemented method and system enabling an Offer Provider to advertise to established Users via electronic communications, and providing Users the ability to respond by making online purchases without entering any alpha numeric data from a computer keyboard or an Electronic Communications Device keypad. The present invention provides a method for established Users of an Offer Provider to make an electronic purchase in response to an advertisement that is sent from the Offer Provider to the User's Electronic Communications Account (e.g., email, text-SMS, instant messaging-IM, and social networking webpages such as Twitter® and Facebook®). The User clicks on a Promotionally Enabled Link (PEL), which is located within the electronic communication advertisement from the merchant. This link has been customized to specifically provide sufficient information to enable the processing and charging of their purchase to financial accounts stored on a computer database accessible only by the Offer Provider. The method and system of the present invention also provide enhanced security of an online purchase by requiring the User whose network credentials have not been verified to confirm their purchase, wherein they must click on a hyperlink within a subsequent electronic confirmation from the Offer Provider to indicate that they agree to the purchase. In alternative embodiments of the present invention, the non-verified User also has the ability to click on a hyperlink within said subsequent electronic communication from the Offer Provider in order to cancel the order. This confirmation and cancellation process prevents third parties without access to the User's electronic communications account from charging the User's financial accounts.

In particular, the present invention comprises a computer program product comprising a machine-readable medium storing machine instructions that, when executed by a server system comprising one or more programmable processors, cause the server system to perform functions comprising: accessing a database storing information comprising Users with Electronic Communications Account addresses and billing information; transmitting, over a communication network, an Offer Provider inputted electronic communication comprising promotional information, the request having been received at the User's electronic communications account; opening a webpage on a User's electronic communications device describing the Offer Provider's Promotional Information in response to a single click performed by the User; receiving, over the communication network from the User to the Offer Provider, a purchase order in response to a single click performed by the User; opening a webpage on the User's Electronic Communications Device comprising instructions for the User to respond to a new electronic communication; transmitting, over a communication network, a message verifying purchase order request, the request having been received at the User's Electronic Communications Account; and receiving, over the communication network, a confirmation or cancellation of the purchase order request in response to a single Click performed from the User's electronic communications account; whereby no alpha numeric data is entered by the User over the communication network at any time.

Likewise, the present invention comprises a system for purchasing a product over the Internet in response to an electronic communication sent from an Offer Provider to an established User, the system comprising: a means for transmitting promotional information to a User's Electronic Communication Account; a means for opening a webpage document in response to a single Click performed by the User who is interested in purchasing the product; a means for placing a purchase order in response to a single Click performed by the User; a means for instructing the Users who have purchased said product to respond to a new electronic communication; and a means for confirming said purchase in response to a single Click performed by the User from said new electronic communication; whereby no alpha numeric data is inputted by the User throughout said method.

The present invention also comprises a system for purchasing a product or service over the Internet in response to an electronic message sent from an Offer Provider to an established User wherein said User does not input alpha numeric data, comprising: an electronic message generation module providing functionality to transmit electronic messages to Users comprising encrypted Promotionally Enabled Links (PELs) specific to each User; a database comprising User's billing information, wherein said database is only accessible to the Offer Provider or merchant represented by Offer Provider of said product or service; and a web page document generation module providing ability to customize Promotional Information for said product or service; and a transaction processing module which is responsive to a payment request to cause a transfer of funds from a User account to a merchant account. The electronic message generation module provides functionality to Offer Providers to transmit electronic messages to Users designated by merchants. The webpage document generation module provides Offer Providers the ability to customize promotional information for a merchant's product or service. And the transaction processing module enables Offer Providers the ability to transfer funds from a User account to a merchant account wherein said Offer Providers electronically transmit the merchant identification, the User identification, the amount of sale, and other attributes defined by the merchant, without transmitting the User's financial account information.

### ECA Single Click Method and User Controlled Confirmation Method

The present invention also comprises a computer implemented method known as “ECA Single Click Method” for purchasing a product over the Internet in response to an electronic communication sent from an Offer Provider to a verified User comprising: transmitting a promotional information message to a User's Electronic Communication Account; opening and viewing said promotional information message by the User; making a purchase in response to a single Click performed by the User within said ECA promotional message; and opening a web page document in response to said single Click whereby said webpage document confirms the purchase by the User; whereby no alpha numeric data is inputted by the User throughout said method.

The present invention comprises a computer program product for the “ECA Single Click Method” comprising a machine-readable medium storing machine instructions that, when executed by a server system comprising one or more programmable processors, cause the server system to perform functions comprising: accessing a database storing information comprising Users with Electronic Communications Account addresses and billing information; transmitting, over a communication network, an Offer Provider inputted electronic communication comprising a Promotional Information message, the request having been received at a verified User's electronic communications account; placing a purchase order in response to a single click performed by the User within said ECA message; and opening a web page document in response to said single Click that provides an Offer Provider message confirming the purchase; whereby no alpha numeric data is inputted by the User throughout said method.

Additionally, the present invention comprises a computer implemented method known as the “User Controlled Confirmation Method” for purchasing a product over the Internet in response to an electronic communication sent from an Offer Provider to an non-verified User comprising: transmitting a promotional information message to a User's Electronic Communication Account; opening and viewing said promotional information message by the User; placing a purchase order in response to a single Click performed by the User within said message; opening a web page document in response to said single Click confirming the purchase; instructing the User within said webpage to select the mode or form of electronic communication to receive a message to confirm again said purchase; transmitting a message to the User via said selected mode comprising instructions to confirm or cancel the purchase; and confirming or cancelling said purchase in response to a single Click performed by the User, whereby no alpha numeric data is inputted by the User throughout said method.

The present invention also comprises a computer program product for the “User Controlled Confirmation Method” method comprising a machine-readable medium storing machine instructions that, when executed by a server system comprising one or more programmable processors, cause the server system to perform functions comprising: accessing a database storing information comprising Users with Electronic Communications Account addresses and billing information; transmitting, over a communication network, an Offer Provider inputted electronic communication comprising a Promotional Information message, the request having been received at a verified User's electronic communications account; placing a purchase order in response to a single click performed by the User within said message; opening a webpage on a User's electronic communications device confirming the purchase; instructing the User within said webpage to select the mode or form of electronic communication to receive a message to confirm again said purchase; transmitting a message to the User via said selected mode comprising instructions to confirm or cancel the purchase; and confirming or cancelling said purchase in response to a single Click performed by the User, whereby no alpha numeric data is inputted by the User throughout said method.

The present invention also comprises a system for purchasing a product over the Internet in response to an electronic communication sent from an Offer Provider to a verified User, known as the system for executing the “ECA Single Click Method”, which comprises: a means for transmitting promotional information to a User's Electronic Communication Account; a means for placing a purchase order in response to a single Click performed by the User; a means for opening a webpage document in response to said single Click performed by the User that confirms the purchase. And for non-verified Users of Offer Provider purchasing, the system for executing a “User Controlled Confirmation Method” comprises the additional following components: within said webpage method, a means for instructing the Users who have purchased said product to select the type of electronic communication they wish to receive in order to confirm or cancel the purchase (e.g. email, SMS/text, or phone call verbal response); a means for transmitting said confirmation or cancellation electronic communication; and a means for receiving a response to a single action (e.g. verbal “Yes/No”) performed by the User from said new electronic communication; whereby no alpha numeric data is inputted by the User throughout said method.

### Exemplification

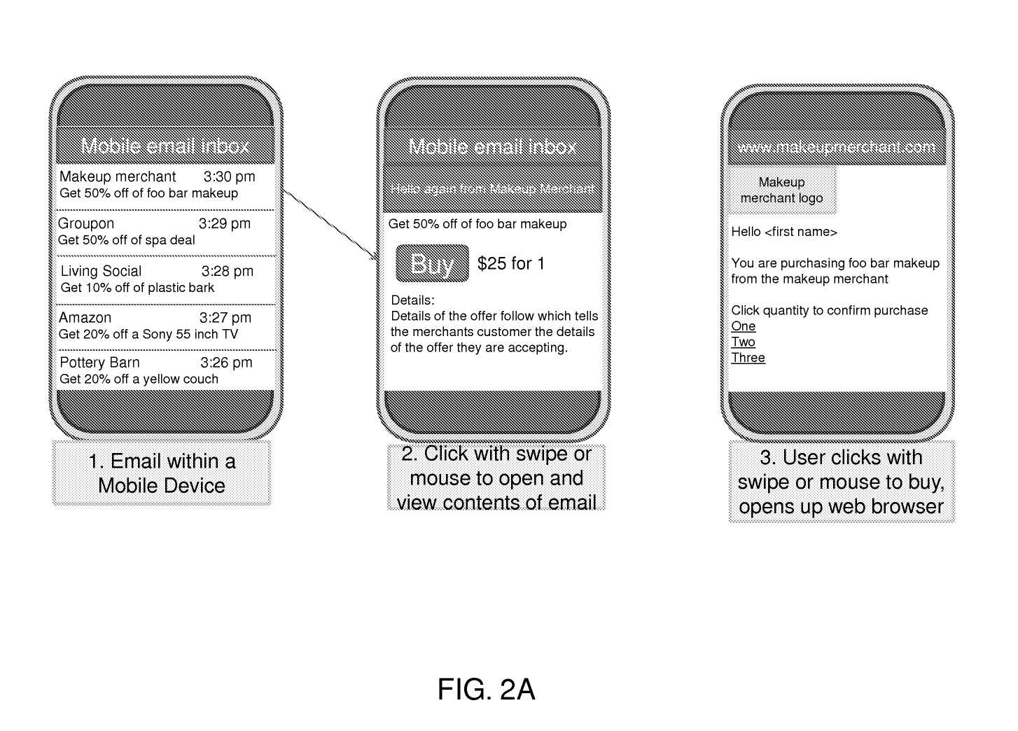

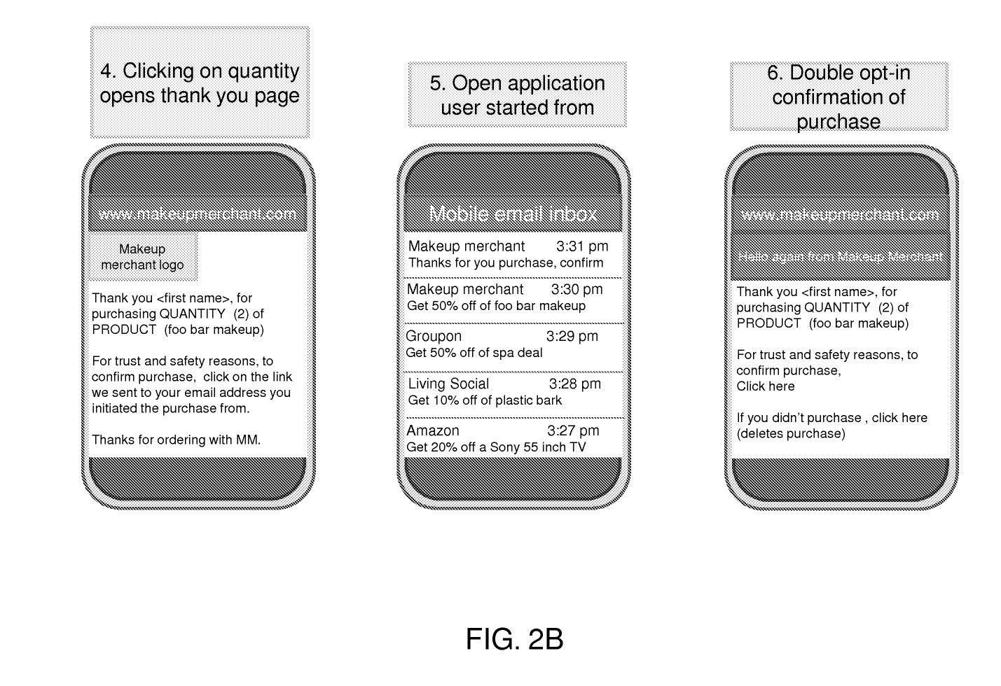

The methodology of the present invention is illustrated in FIGS. 2A and 2B wherein an Offer Provider transmits a promotional message (e.g. advertisement) for their product or services to select Users for whom (1) the Offer Provider has billing information on file, (2) their accounts are current (e.g. paid in full), and optionally, (3) they have previously indicated that they would be interested in receiving correspondence from the merchant for notifications on their products and/or services. The User opens and reads the electronic communication from their Electronic Communications Account, and then clicks on the “Buy” tab to initiate a purchase. They are re-directed to webpage that addresses them by their name or a unique greeting, describes the product or service, and optionally, the quantity that may be purchased (e.g. one tab each for a quantity of “One”, “Two”, or “Three”). After the User clicks on which quantity they desire to purchase, the webpage will instruct them to respond to a new message sent to their Electronic Communications Account (ECA) to confirm the purchase. When they click on a Promotionally Enabled Link (PEL) within their ECA from the Offer Provider, their order will be processed and their financial accounts billed.

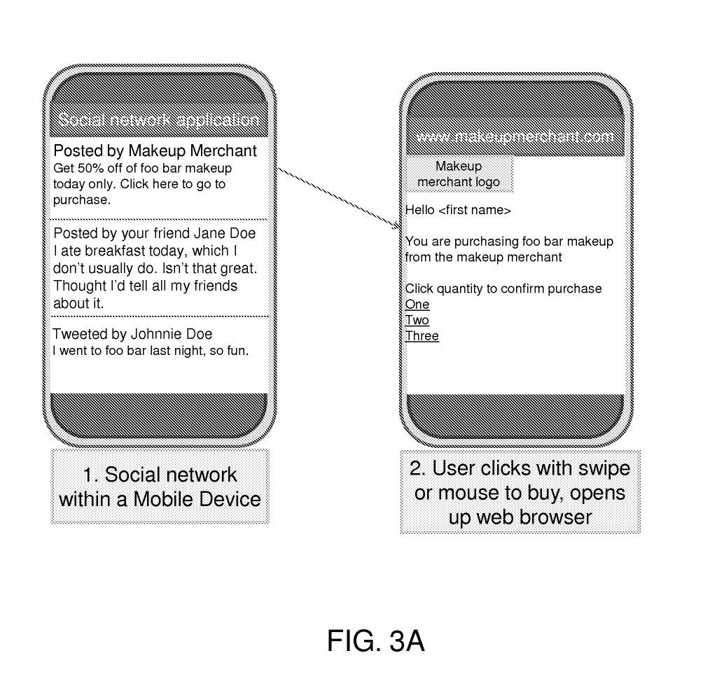

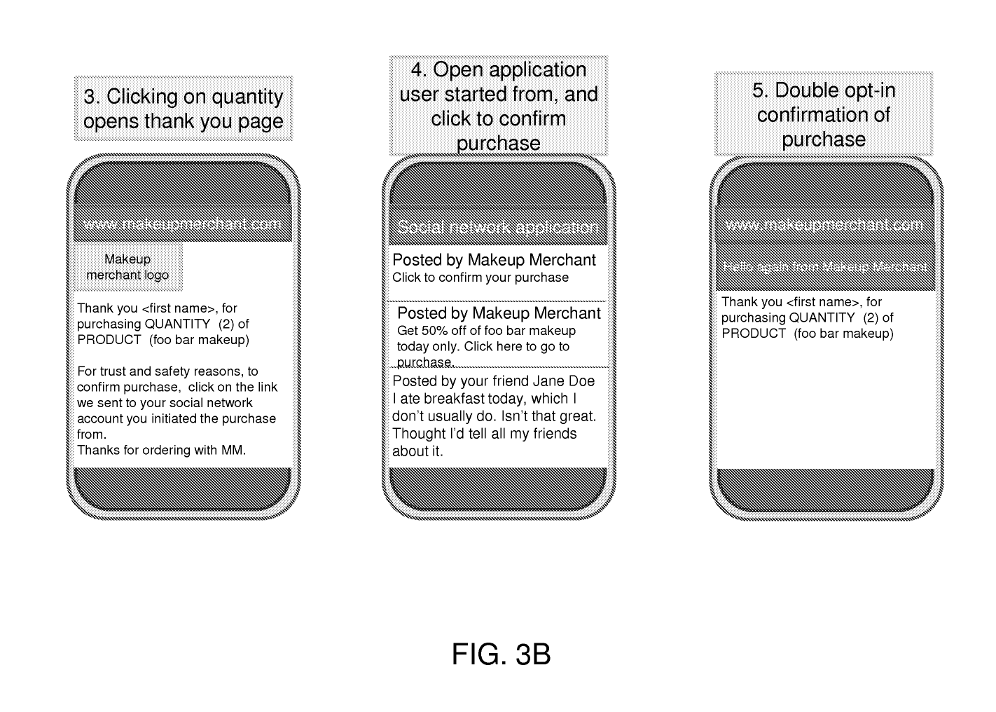

Likewise, FIGS. 3A and 3B illustrate an exemplification of the present invention using a promotional message sent by an Offer Provider to a User's social media or (social) networking site as viewed on their mobile device. Because the User's shipping and billing information is already on file with the merchant, the User is only required to click three times to make and confirm the purchase, while not being required to (log in or) enter any of their personal data for enhanced security. If the User shares the Offer Provider's advertisement with their friends and one of them attempts to make a purchase, the confirmation with an embedded Promotionally Enabled Link (PEL) is sent to User's social network account. The User would not click on the link to confirm the purchase.

One of ordinary skill in the art could readily implement other embodiments of the present invention. For example, the advertisement may comprise selecting additional options, including but not limited to, shipping address and method, product color and size. Additionally, other features of the present invention may comprise additional non-alpha numeric data entry steps, such as requiring a User to respond to a question asking to verify their identity before confirming the purchase. And, different forms of electronic communication are covered within the present invention. For example, when an Offer Provider sends an SMS/text to a User, who then forwards it to a Non-User entity such as a friend via SMS or email, the order confirmation will be sent from the Offer Provider to the User's SMS/Text account, and not to the friend's SMS or email account. Methods of emailing, texting, posting, and instant messaging to electronic communications devices are well known in the art. And various features of the invention may be implemented within conventional webpages that are based on HTML (Hypertext Markup Language), and may also be implemented within webpages that use HDML (Handheld Device Markup Language), XML (Extensible Markup Language), and other coding conventions.

In all of the methods of the present invention, the User who receives the advertisement via electronic communication must have a “pre-existing” account with the merchant, meaning that the Offer Provider or merchant represented by the Offer Provider must have previously acquired the User's information sufficient for the User to process payments, as well as at least one of the User's electronic communications addresses (for example email, SMS/text, Facebook® account).

The present invention may be implemented in a variety of scenarios comprising, for example, the Offer Provider alone conducting all aspects of the advertising, process order verification and billing, and product delivery via the use of licensed software. Or, various aspects of the process may be subcontracted to third parties by the Offer Provider. Or third party service providers may represent various Offer Providers in advertising and processing of purchasing. In all scenarios, Users are assigned a unique User ID that may be provided to third party service providers (e.g., an email service provider). This unique User ID is encrypted by methods well known in the art.

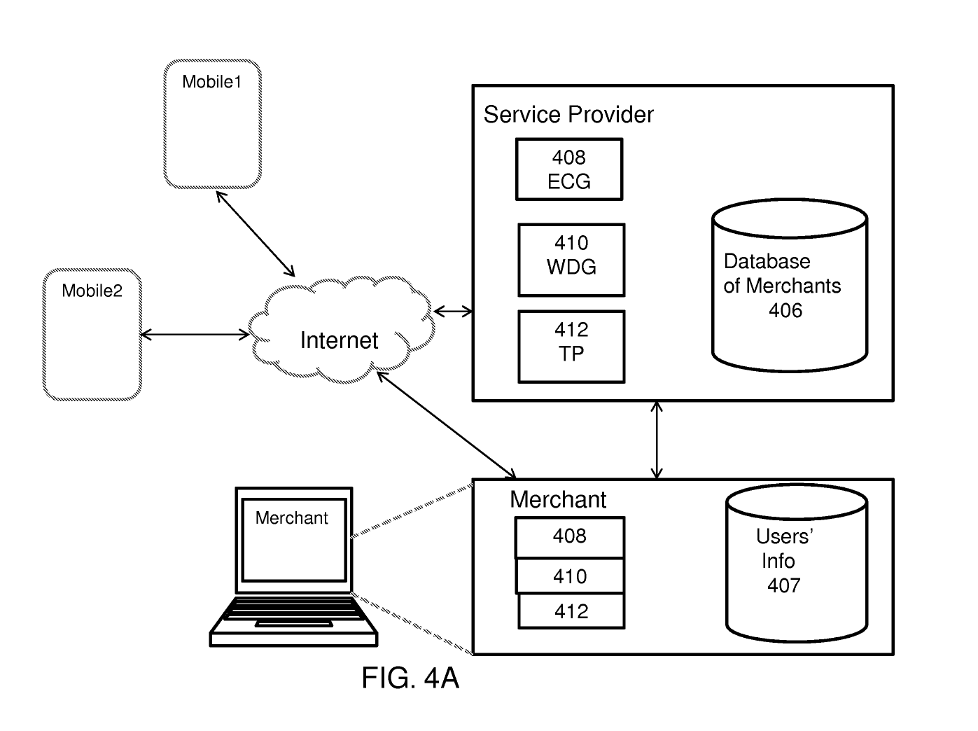

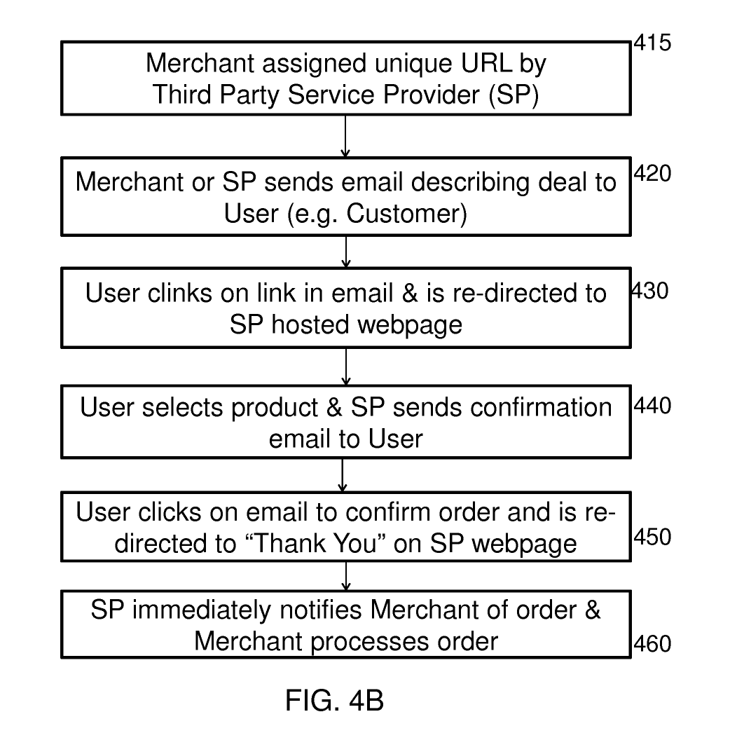

System Architecture: the system of the present invention for all scenarios follows the industry standard for User client computing devices being in communication via a network, such as the Internet, with a system server that comprises components well known in the art: one or multiple high speed CPU's (Central Processing Unit(s)), primary memory (i.e. RAM) and secondary storage device(s) (i.e. hard disk drives), etc. . . . An exemplification of a particular embodiment of the present invention incorporating the use of third party service provides (SP) is shown in FIG. 4A that demonstrates a SP communicating promotional messages to Users, and then forwarding purchase orders to merchants for processing. Alternatively a merchant or Offer Provider client computing device directly communicates to User's the promotional message (e.g. peer-to-peer computing) wherein all computer programming modules of the present invention are housed on the merchant's computing device. One of ordinary skill in the art would readily know of synonymous system architectures for alternative embodiments of the present invention. The computing devices may be a workstation (e.g. a laptop or desktop computer) (FIG. 4A, 402) or a mobile communications device (e.g. a smartphone 404), both with web browser capabilities for viewing and responding to emails and webpage hyperlinks. The User client computing devices are in communication via a network with a system server of the third party Service Provider (SP), who transmits and receives the User's electronic purchases. The SP system server houses a database 406 storing records for each merchants User contact information and may also store financial account information sufficient to electronically charge a User's account in lieu of a merchant billing the accounts. The system architecture also comprises a merchant system server, housing a database 407 of User contact, complete billing and shipping information; order history, etc. . . . The SP system or merchant system also houses computer program products, applications, and/or modules of the present invention comprising: an electronic message generation module 408 providing functionality for transmitting electronic messages to Users comprising encrypted links unique to each User; a webpage document generation module 410 confirming the purchase of said product or service; and, a transaction processing module 412 which is responsive to a payment request to cause a transfer of funds from a User account to the Offer Provider account. For verified Users, the system further comprises that said electronic message generation module 408 possess functionality for placing a purchase and redirecting the User to a webpage that confirms the purchase in response to a single click performed by the User within the electronic message. And for non-verified Users, the system comprises that the webpage document generation module 410 possess functionality for the non-verified User to select a form of electronic communication to receive from the Offer provider a second confirmation of the purchase in response to a single click performed by the User within the same webpage document. And the system for non-verified Users further comprises an electronic communications module for automatically transmitting to the User the second confirmation in a form selected from the group consisting of email, SMS/text message, or phone call, and wherein said phone call requires a short verbal response from the User (e.g. Y or N) to confirm or cancel the purchase, and wherein the email and SMS/text message require a single Click performed by the User to confirm or cancel the purchase.

Third Party Providers: A third party service provider (e.g. an email service provider) transmits advertisements to Users whom merchants as Offer Providers have provided them contact information for comprising, for example, an email address if they are sending email, the User's AccountID if they are posting to a social network site (e.g. Facebook/Twitter), or a cell phone number if sending an SMS/Text. Therefore, the 3rd party service provider only needs to possess the specific contact information that is required to send the message to the appropriate account

In system structures utilizing third party advertisement transmission, a multitude of alternative features of the present invention are permissible that allow different aspects of the process to be completed by the various parties. For example, the third party or the merchant as Offer Provider may generate the electronic communications to the User to verify the order accuracy. Additionally, purchased products may be delivered to the User after payment has been processed by the merchant or by the third party service provider or by another designated entity. Payment may also be processed by the merchant, or by the third party service provider using a payment gateway service provider via API. The confirmation of payment can be sent to the merchant's payment gateway after the final confirmation electronic communication is achieved by the User. Those skilled in the art understand that there are multiple ways via API's and web services to securely provide information to the payment gateways to fulfill the order in a way that does not pass personal contact information or billing information. Namely, the parameters that most payment gateways require are: the merchant ID, User ID, and amount of sale.

In a preferred embodiment of the present invention, the system and method are implemented using “cloud computing” technology wherein a third party service provider transmits the advertisements to the User's electronic communications account under the direction of the merchant as Offer Provider, verifies the accuracy of the purchase by transmitting a subsequent electronic communication to the User in real-time, and then either notifies the merchant or the merchants payment gateway of the purchase via API and transmits the encrypted User ID and the amount of the transaction.

Information is exchanged between the merchant and service provider by methods readily known in the art, such as: 1) parameters passed by Uniform Resource Locators (URL) or API web; and/or 2) as data pre-loaded by the merchant. By way of exemplification, parameters passed in URL for the present invention may comprise: the merchant identification (MerchantID); the User identification (encrypted) (UserID); which User's Electronic Communications Accounts advertisement is sent (e.g. email, SMS, social networking account, etc. . . .) (LinkChannels); and the advertisement or deal identification (DealID). Likewise, data that is stored within the merchant's or service provider's database may comprise: User's first name (UserFirstName); date and/or time of deal's expiration (DealExpires); description of the deal (DealContent); and purchase quantities available for online purchases by a User (e.g., 1, 2, 3, etc. . . . ) (Deal Quantities), where they want order shipping (e.g., home or business) (shipping preferences). Other types of data may be readily incorporated into the present invention by one of ordinary skill in the art.

The information exchanged between the merchant as Offer Provider and the service provider enables the service provider to create a webpage specific to a merchant comprising the merchant's identifying information, such as logos or trademarks, and the User's name. The service provider can also create a webpage specific to each User's requirements (e.g., web browser, electronic communications device and account) by methods well known in the art. For example, when the User clicks on the Promotionally Enabled Link within their electronic communication message, they will be directed to a service provider created merchant specific webpage. If the User clicks to place an order, they will view a service provider webpage with a salutation specific to the User.

FIG. 4B provides a flowchart of events occurring during the preferred embodiment of a third party service provider enabling Offer Providers, specifically merchants, to advertise, accept and place purchase orders, while permitting the merchants to process billing and product delivery. When the merchant registers with the service provider, they are assigned a unique URL 415 that the service provider will utilize to pass data parameters to the merchant when a purchase is made. Additional parameters passed beyond those stated are readily apparent to one of ordinary skill in the art. Subsequently, the merchant, or the service provider (SP), generates and transmits an advertisement or deal of a product or service via an electronic communication 420 to established Users. If the User clicks (click 1) on the PEL embedded within the communication 430, then they will be re-directed to a webpage hosted by the service provider and created specifically for the merchant's advertisement and the User. For example, a PEL that redirects to the service provider may comprise the parameter: ?deal=123 which describes the deal, ?merchant=xyz, which tells the service provider what merchant the deal is for, and “custhash=9098788492” is the encrypted User identification (UserId) specific to the User. The webpage hosted by the service provider can also request information from the merchant, for example if the deal is still available (dealavailable=y or n), whether to ship to home or work (ship=h or w), and other parameters that are agreed upon between the merchant and service provider. The User subsequently clicks (click 2) 440 to place the order. Any attribute that does not require alpha numeric data entry can be enabled for the User to click on, such as the quantity of items or services purchased, shipping preference, product color, product size or a combination of these attributes, such as 1 red x-large. The User is subsequently instructed on the webpage to respond to a new message sent to their Electronic Communication Account; and concurrently the service provider sends in (near or as close to) real-time the new confirmation message to the User's Electronic Communication Account. The User must open the message and click on a link (click 3) 450 to confirm the purchase. The service provider subsequently notifies the merchant 460 in (as close to) real-time that the User confirmed the purchase of the product or service so that they may process the User's order and payment, wherein the service provider passes to the merchant as data parameters values defined by merchant and servicer provider. For example, parameters passed may comprise but are not limited to: the User identification number (UserID); the advertisement or deal identifier (DealID); the quantity ordered (DealQuantityAccepted); Amount of payment (PaymentAmount) and which link channel the purchase was made from (e.g. email, SMS, IM, Facebook®, Twitter®, etc. . . . ) (LinkChannelAccepted). If there is difficulty in the merchant processing the payment, due to an expired credit card or similar condition, then the merchant is responsible for resolving the matter directly with the User. The present invention also accommodates situations in which a User may forward the advertisement which includes the PEL to a Non-User entity who they believe may be interested in the advertisement, wherein the receiver may or may not have an account with the merchant. When the receiver clicks on the hyperlink, the same webpage will open as for the original intended User. There will be a personally identifiable statement in the webpage such as “Hello User First Name, if you are not {User First Name}, then click here to purchase the product.” Once the receiver clicks on the “click here” link, it will take them to a page where the receiver can start the authentication and payment process via the merchant's normal Internet purchase procedure.

In an alternative embodiment of the present invention, the merchant or Offer Provider is solely responsible for all aspects of advertising, billing, and purchase order delivery. A software package is licensed to the Offer Provider to enable them to create custom PELs to insert into electronic communications that allow the User to complete an order at the Offer Provider's webpage without entering any alpha numeric data, such as personal or billing information or having to log into their account. The software enables a merchant to incorporate programming code into their electronic communications that they are sending to select Users, (e.g. whose (1) accounts are current, (2) merchant has billing information on file, and optionally, (3) they have previously indicated that they would be interested in receiving advertisements from the merchant. The computer programming code would also include a module for the merchant or Offer Provider to encrypt and decrypt the UserIds as needed. When the User clicks on the PEL from their electronic message, they are re-directed to the Offer Provider's or merchant's webpage wherein the User sees details of the product or service being offered and a link or button. The User will view the same electronic messages and webpages, and proceed through the same “no data entry” process whether the messages are sent and processed by the Offer Provider, merchant or a third party service provider, as exemplified in FIGS. 2A, 2B, 3A, and 3B.

### ECA Single Click Method

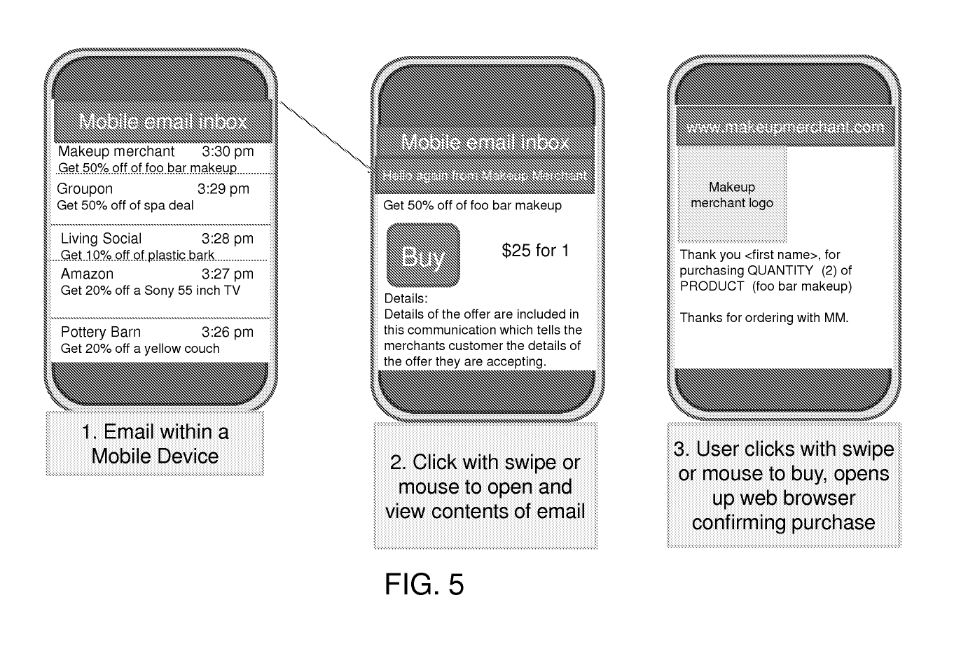

As illustrated in FIG. 5, alternative method of the present invention comprises a single click purchase and confirmation method, the “ECA Single Click Method”. It is applicable for a User whose identity has been previously verified by the Offer Provider. Prior verification occurs in situations wherein the User has already logged into the merchant's website, has saved their username and password on their electronic communications device, and/or is verified by cookies or other method well known by the skilled artisan (e.g. by the merchant via web browsers having saved their credentials). Methods of credentialing are well known to those of skill in the art of electronic communications. In the digital environment, a credential is a data structure or an electronic document which has a defined structure known to all involved parties, and is issued by an authority (sometimes referred to as a trusted source). They may also have additional data (i.e. a digital signature) that “ties” the document content to the issuer.

### User Controlled Confirmation Method

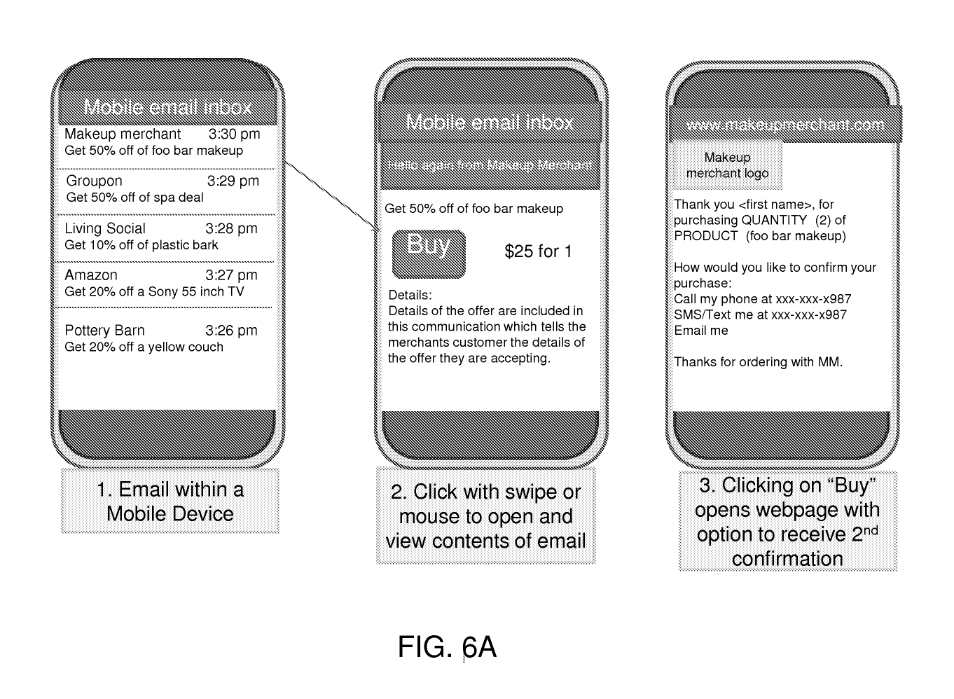

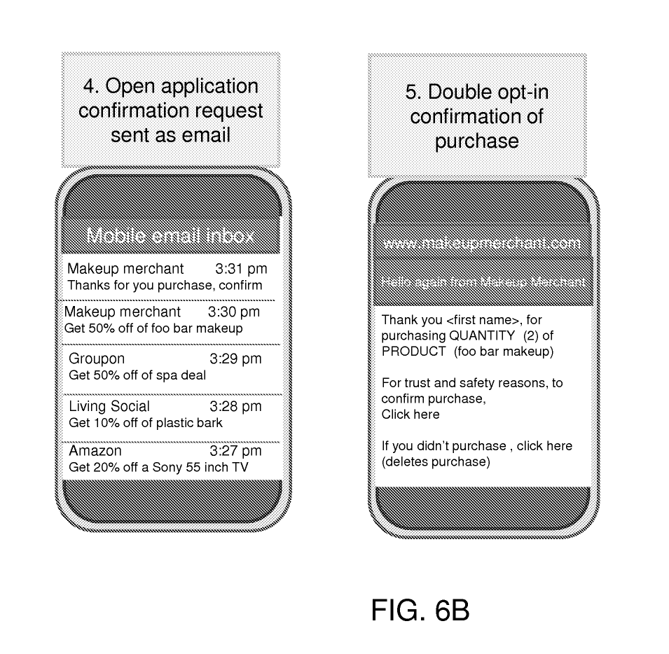

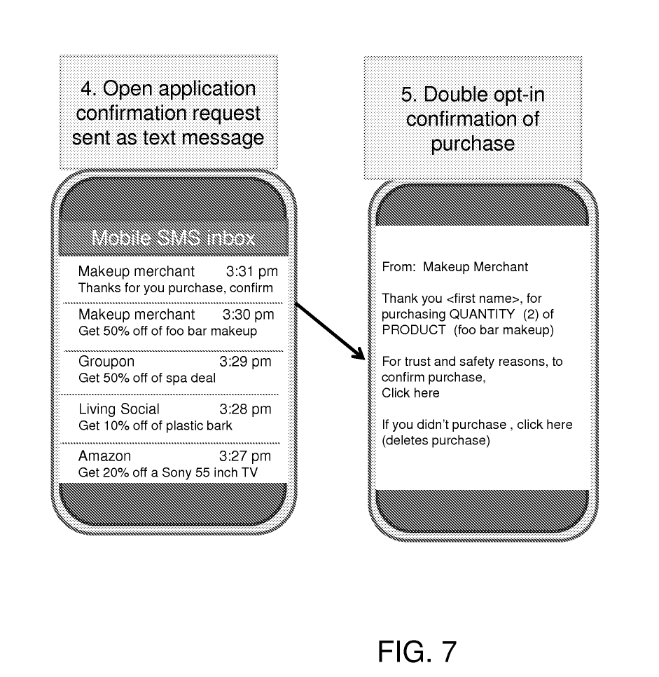

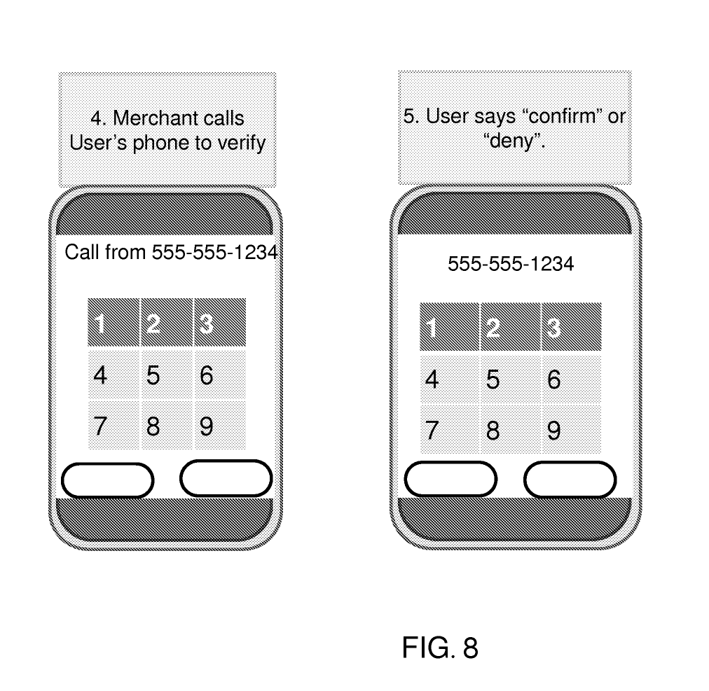

As illustrated in FIGS. 6-8, additional features of the present invention comprise providing the User alternative methods of confirming their order (e.g., email notification, SMS/text notification, and/or mobile phone call notification with voice response), in combination with the ability to cancel a purchase. FIG. 6A provides an exemplification of the Offer Provider transmitting an advertisement (e.g. special offer) for their product or services to select Users for whom (1) the Offer Provider has billing information on file, (2) their accounts are current (e.g. paid in full), and optionally, (3) they have previously indicated that they would be interested in receiving correspondence from the merchant for notifications on their products and/or services. The User opens and reads the electronic communication from their Electronic Communications Account, and then clicks on the “Buy” tab to place a purchase. They are re-directed to webpage that addresses them by their name or a unique greeting, thanks them and describes the product or service, and asks how they would like to confirm their purchase: via the Offer Provider emailing, texting, or calling them. If the user selects “email” confirmation, then they will receive an email message in their Electronic Communications Account (ECA). When they click on a Promotionally Enabled Link (PEL) within their ECA from the Offer Provider, their order will be processed and their financial accounts billed. In lieu of clicking on the PEL confirming the purchase, the User may click on a cancellation link to delete their purchase (See FIG. 6B). Alternatively, if a User selects an SMS/text confirmation in FIG. 6A, they will receive a text message as demonstrated in FIG. 7 comprising the same PEL and option to cancel the order as shown in FIG. 6B. And in yet another alternative embodiment of the present invention, the User may opt to receive a telephone call as per FIG. 6B. The Offer Provider would subsequently telephone the User at the telephone number on their account with the merchant. The User would respond verbally to confirm (e.g. “Yes” response) or to cancel (e.g. “No” response) the order (See FIG. 8).

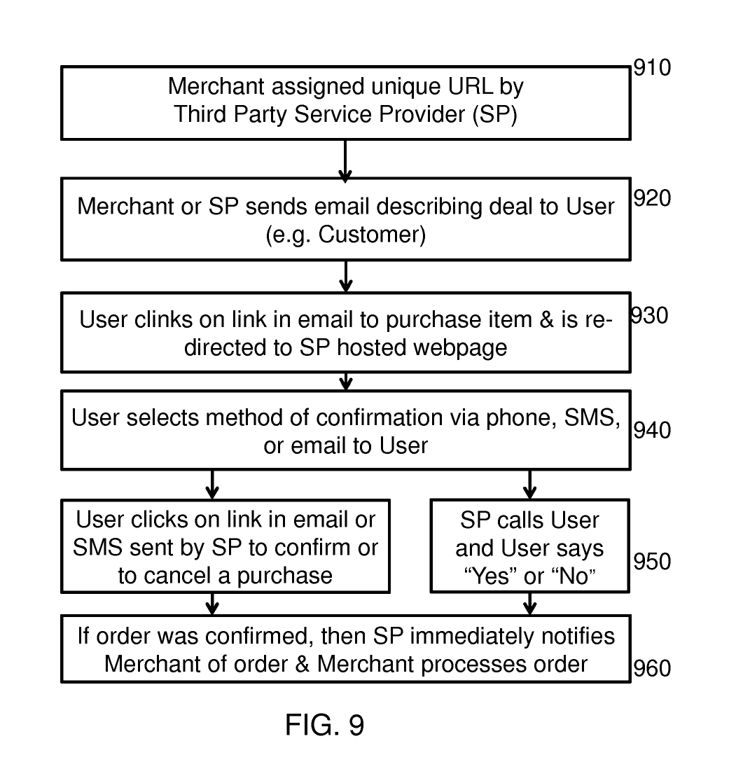

FIG. 9 provides a flowchart of events occurring during the exemplified “User Controlled Confirmation Method” with a third party service provider enabling Offer Providers, specifically merchants, to advertise, accept and place purchase orders, while permitting the merchants to process billing and product delivery. When the merchant registers with the service provider, they are assigned a unique URL 910 that the service provider will utilize to pass data parameters to the merchant when a purchase is made. Additional parameters passed beyond those stated are readily apparent to one of ordinary skill in the art. Subsequently, the merchant, or the service provider (SP), generates and transmits an advertisement or deal of a product or service via an electronic communication 920 to established Users. The User clicks on the PEL embedded within the communication (e.g. “Buy” tab) 930 in order to place a purchase. They will then be re-directed to a webpage hosted by the service provider and created specifically for the merchant's advertisement and the User. For example, a PEL that redirects to the service provider may comprise the parameter: ?deal=123 which describes the deal, ?merchant=xyz, which tells the service provider what merchant the deal is for, and “custhash=9098788492” is the encrypted User identification (UserId) specific to the User. The webpage hosted by the service provider can also request information from the merchant, for example if the deal is still available (dealavailable=y or n), whether to ship to home or work (ship=h or w), and other parameters that are agreed upon between the merchant and service provider. In this particular exemplification, the User subsequently selects their preferred method 940 to confirm the order by phone, SMS/text, or email, although other forms of electronic communication are readily apparent to one of ordinary skill in the art. The service provider sends in (near or as close to) real-time the new confirmation message to the User's Electronic Communication Account if the User's chosen method of confirmation was via email or SMS/text. The User must open the message and click on a link 950 to confirm the purchase. Alternatively, if the User chose confirmation via a phone call, then the SP will call the User at the phone number on record with the merchant. The User must then verbally respond with the appropriate response as per the instructions so as to confirm the order (e.g. “Yes” or “Confirm”), or to cancel the order (e.g. “No” or “Decline”). If the order was confirmed by the User via any of the outlined methods of email, SMS, or phone call, then the SP subsequently notifies the merchant 960 in (as close to) real-time that the User confirmed the purchase. The merchant processes the User's order and payment using data parameters passed to the merchant by the SP. For example, parameters passed may comprise but are not limited to: the User identification number (UserID) ; the advertisement or deal identifier (DealID); the quantity ordered (DealQuantityAccepted); Amount of payment (PaymentAmount) and which link channel the purchase was made from (e.g. email, SMS, IM, Facebook®, Twitter®, etc. . . . ) (LinkChannelAccepted). If there is difficulty in the merchant processing the payment, due to an expired credit card or similar condition, then the merchant is responsible for resolving the matter directly with the User.

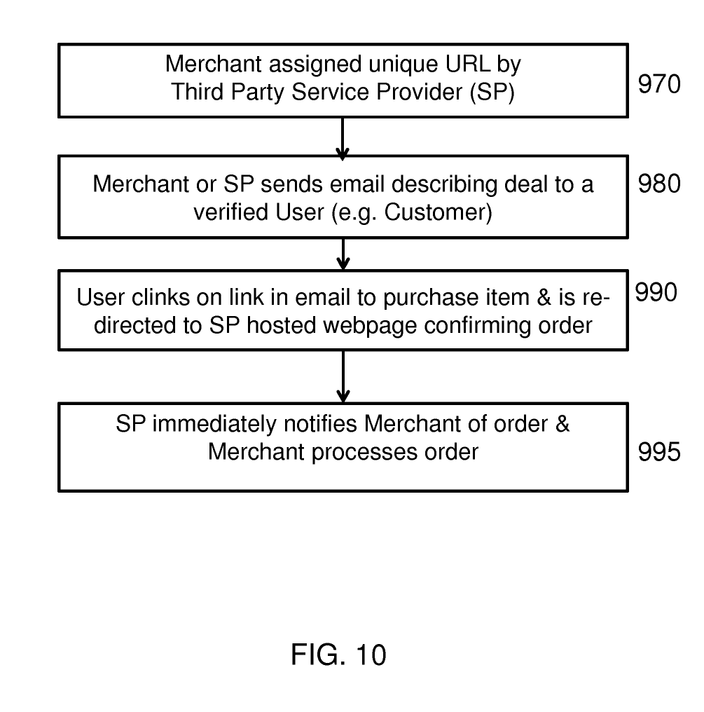

FIG. 10 provides a flowchart of events occurring during the exemplified “ECA Single Click Method” with a third party service provider enabling Offer Providers, specifically merchants, to advertise, accept and place purchase orders, while permitting the merchants to process billing and product delivery. When the merchant registers with the service provider, they are assigned a unique URL 970 that the service provider will utilize to pass data parameters to the merchant when a purchase is made. Additional parameters passed beyond those stated are readily apparent to one of ordinary skill in the art. Subsequently, the merchant, or the service provider (SP), generates and transmits an advertisement or deal of a product or service via an electronic communication 980 to established, verified Users. The User clicks on the PEL embedded within the communication (e.g. “Buy” tab) 990 in order to place a purchase. They will then be re-directed to a webpage hosted by the service provider confirming the order and created specifically for the merchant's advertisement and the User. For example, a PEL that redirects to the service provider webpage may comprise the parameter: ?deal=123 which describes the deal, ?merchant=xyz, which tells the service provider what merchant the deal is for, and “custhash=9098788492” is the encrypted User identification (UserId) specific to the User. The SP immediately notifies the merchant of the verified User's order and the merchant processes the order 995 and payment using data parameters passed to the merchant by the SP. For example, parameters passed may comprise but are not limited to: the User identification number (UserID) ; the advertisement or deal identifier (DealID); the quantity ordered (DealQuantityAccepted); Amount of payment (PaymentAmount) and which link channel the purchase was made from (e.g. email, SMS, IM, Facebook®, Twitter®, etc. . . . ) (LinkChannelAccepted). If there is difficulty in the merchant processing the payment, due to an expired credit card or similar condition, then the merchant is responsible for resolving the matter directly with the User.

Although the invention has been described in terms of certain preferred embodiments (e.g. advertisements sent via email), other embodiments that are apparent to those of ordinary skill in the art (e.g. advertisements sent via SMS, IM instant messaging, and electronic messages or posts sent to social networking accounts), including embodiments which do not provide all of the features and advantages set forth herein, are also within the scope of this invention. Accordingly, the scope of the invention is defined by the claims.

What is claimed is:

1. A method of purchasing a product or service over the Internet in response to an electronic communication sent from an Offer Provider to a User's Electronic Communications Device comprising:
a) transmitting a promotional information message to a User's Electronic Communication Account;
b) opening and viewing said promotional information message by the User;
c) making and confirming a purchase in response to a single Click performed by the User within said ECA message;
d) opening a web page document in response to said single Click whereby said document notifies the User that the purchase is confirmed; and
e) whereby no alpha numeric data is inputted by the User throughout said method.

2. A method of claim 1 further comprising:
a) instructing the User within said webpage to select the form of electronic communication to receive a message to confirm a second time said purchase;
b) transmitting a message to the User via said selected form comprising instructions to confirm or cancel the purchase;
c) confirming or cancelling said purchase in response to a single Click performed by the User; and
d) whereby no alpha numeric data is inputted by the User throughout said method.

3. The method of claim 1, wherein said User is verified.

4. The method of claim 2, wherein said User is non-verified and wherein said mode of communication is selected from the group consisting of email, SMS, and telephone call.

5. The method of claim 1, wherein said promotional information comprises User identification within a link and encrypted before sending to said User and decrypted by said Offer Provider to process said User's purchase.

6. The method of claim 2, wherein said promotional information comprises User identification within a link and encrypted before sending to said User and decrypted by said Offer Provider to process said User's purchase.

7. The method of claim 1, wherein said electronic communication account comprises email, SMS, IM instant messaging, and electronic messages or posts sent to social networking accounts.

8. The method of claim 2, wherein said electronic communication account comprises email, SMS, IM instant messaging, and electronic messages or posts sent to social networking accounts.

9. A computer program product comprising a machine-readable medium storing machine instructions that, when executed by a server system comprising one or more programmable processors, cause the server system to perform functions comprising:
a) accessing a database storing information comprising Users with Electronic Communications Account addresses and billing information;
b) transmitting, over a communication network, an Offer Provider inputted electronic communication comprising a Promotional Information message, the request having been received at a User's electronic communications account;
c) placing and confirming a purchase order in response to a single click performed by the User within said message; and
d) opening a webpage on a User's electronic communications device notifying the User that the purchase is confirmed;
e) whereby no alpha numeric data is entered by the User over the communication network at any time.

10. A computer program product of claim 9, further comprising a machine-readable medium storing machine instructions that, when executed by a server system comprising one or more programmable processors, cause the server system to perform functions comprising:
a) instructing the User within said webpage to select the form of electronic communication to receive a message to confirm a second time said purchase;
b) transmitting a message to the User via said selected form comprising instructions to confirm or cancel the purchase; and
c) confirming or cancelling said purchase in response to a single Click performed by the User,
d) whereby no alpha numeric data is inputted by the User throughout said method.

11. The computer program product of claim 9, wherein said User is verified.

12. The computer program product of claim 10, wherein said User is non-verified and wherein said form of message communication is selected from the group consisting of email, SMS/text message, and telephone call.

13. The computer program product of claim 9, where said electronic communication account comprises email, SMS, IM instant messaging, and electronic messages or posts sent to social networking accounts.

14. The computer program product of claim 10, where said electronic communication account comprises email, SMS, IM instant messaging, and electronic messages or posts sent to social networking accounts.

15. The computer program product of claim 9, wherein said promotional information comprises User identification encrypted within a link before sending to said User and wherein said User identification is decrypted by said Offer Provider prior to processing the purchase order request.

16. The computer program product of claim 10, wherein said promotional information comprises User identification encrypted within a link before sending to said User and wherein said User identification is decrypted by said Offer Provider prior to processing the purchase order request.

17. The computer program product of claim 9, wherein said User's billing information is stored in a database accessible only by Offer Providers and preventing fraudulent and accidental purchases by Non-User entities.

18. The computer program product of claim 10, wherein said User's billing information is stored in a database accessible only by Offer Providers and preventing fraudulent and accidental purchases by Non-User entities.

19. A system for purchasing a product or service over the Internet in response to an electronic message sent from an Offer Provider to an established User wherein said User does not input alpha numeric data, comprising:
a) an electronic message generation module providing functionality to transmit electronic messages to Users comprising encrypted links unique to each User, wherein in response to a single click performed by the User on said link a purchase is placed and the User is redirected to a webpage confirming the purchase;
b) a database comprising User's billing information, wherein said database is only accessible to the Offer Provider of said product or service;
c) a webpage document generation module confirming the purchase of said product or service; and,
d) a transaction processing module which is responsive to a payment request to cause a transfer of funds from a User account to said Offer Provider account.

20. The system of claim 19, wherein said webpage document generation module further comprises instructions directing a non-verified User to select a method for receiving a second confirmation of said purchase in response to a single click performed by the User on a hyperlink within the webpage, said methods are selected from the group consisting of email, SMS/text message, or phone call.

21. The system of claim 20, further comprising an electronic communications module for automatically transmitting to said non-verified User a second confirmation wherein said phone call requires a short verbal response from the User to confirm or cancel said purchase, and wherein said email and SMS/text message requires a single Click performed by the User to confirm or cancel said purchase.

22. The system of claim 20, further comprising an electronic message generation module providing functionality to exchange electronic messages with said Offer Provider to deliver additional information about the promotional message prior to transmitting said second confirmation to a User.

23. The method of claim 2, further comprising exchanging electronic messages with said Offer Provider to deliver additional information about the promotional message prior to confirming or cancelling said purchase.

24. A computer program product of claim 10, further comprising a machine-readable medium storing machine instructions that, when executed by a server system comprising one or more programmable processors, cause the server system to perform functions comprising exchanging electronic messages with said Offer Provider to deliver additional information about the promotional message prior to confirming or cancelling said purchase.
